(19) United States
(12) Patent Application Publication
(10) Pub. No.: US 2004/0098928 A1
(43) Pub. Date: May 27, 2004

(54) Block roughening assembly and method

(76) Inventors: Ronald James Scherer, Shakopee, MN (US); Paul W. Bailey, Sarasota, FL (US)

Correspondence Address: MERCHANT & GOULD PC, P.O. BOX 2903, MINNEAPOLIS, MN, 55402-0903, US

(21) Appl. No.: 10/304,164

(22) Filed: Nov. 25, 2002

(51) Int. Cl. B28B 11/12; B28B 11/18; B28B 17/00; B26D 1/02

(52) U.S. Cl. 52/98; 264/157; 264/162; 425/289; 425/291; 425/309; 52/604

(57) ABSTRACT

A concrete block produced from a workpiece that includes at least a portion of a top surface that is roughened by a roughening assembly. The roughening assembly may include a shaft having a plurality of roughening members, the shaft being rotated in a direction opposed to the movement of the workpiece. A splitting mechanism is provided downstream of the roughening assembly to split the workpiece into one or more blocks. The blocks may be placed in a wall having a setback, with the roughened top surface of each block enhancing a natural appearance of the ledge created as a result of the setback.

### FIELD OF THE INVENTION

The invention relates generally to the manufacture of concrete blocks. More specifically, it relates to equipment and processes for the creation of decorative surfaces on concrete blocks. Even more specifically, the invention relates to equipment and processes for producing irregular textures and an appearance of weathered or rock-like edges and surfaces on concrete blocks, as well as concrete blocks that result from such equipment and processes.

### BACKGROUND OF THE INVENTION

It has become common to use concrete blocks for landscaping purposes. Such blocks are used to create, for example, retaining walls, ranging from small tree ring walls and garden edging walls to comparatively large structures. Concrete blocks are made in high speed production plants and typically are exceedingly uniform in appearance. This is not an undesirable characteristic in some landscaping applications, but it is a drawback in applications where there is a demand for a more “natural” appearance to the material used to construct the walls and other landscaping structures.

One way to make concrete blocks less uniform, and more “natural” appearing, is to use a splitting process to create an irregular front face, often referred to as a “rock-face,” on the block. In this process, as it is commonly practiced, a large concrete workpiece that has been adequately cured is split or cracked apart to form two blocks. The resulting blocks have faces along the plane of splitting or cracking that are textured and irregular. This process of splitting a workpiece into two concrete blocks to create an irregular, rock-like appearance on the exposed faces of the blocks is shown, for example, in Besser's U.S. Pat. No. 1,534,353, which discloses the manual splitting of blocks using a hammer and chisel.

Automated equipment to split block is well-known and generally includes a splitting apparatus having a supporting table and opposed, hydraulically-actuated splitting blades. A splitting blade in this application is typically a substantial steel plate that is tapered to a relatively narrow or sharp knife edge. The blades typically are arranged so that the knife edges will engage the top and bottom surfaces of the workpiece in a perpendicular relationship with those surfaces and arranged in a coplanar relationship with each other. In operation, the workpiece is moved onto the supporting table and between the blades. The blades are brought into engagement with the top and bottom surfaces of the workpiece. An increasing force is exerted on each blade, urging the blades towards each other. As the forces on the blades are increased, the workpiece splits (i.e., cracks), generally along the plane of alignment of the blades.

These machines are useful for the high-speed processing of blocks. They produce an irregular, rock-face finish on the blocks. No two faces resulting from this process are identical, so the blocks are more natural in appearance than standard, non-split blocks. However, the edges of the faces resulting from the industry-standard splitting process are generally well-defined, i.e., regular and “sharp.”

It is known to make concrete blocks look more natural by eliminating the regular, sharp edges. One known process for eliminating the regular, sharp edges is the process known as tumbling. In this process, a relatively large number of blocks are loaded into a drum that is rotated around a generally horizontal axis. The blocks contact one another, knocking off the sharp edges, and also chipping and scarring the edges and faces of the blocks. The process has been commonly used to produce a weathered, “used” look to concrete paving stones. These paving stones are typically relatively small blocks of concrete. A common size is 3.75 inches wide by 7.75 inches long by 2.5 inches thick, with a weight of about 6 pounds. The tumbling process is also used with some retaining wall blocks to produce a weathered, less uniform look to the faces of the blocks.

There are several drawbacks to the use of the tumbling process in general, and to the tumbling of retaining wall blocks, in particular. In general, tumbling is a costly process. The blocks must be very strong before they can be tumbled. Typically, the blocks must sit for several weeks after they have been formed to gain adequate strength. This means they must be assembled into cubes, typically on wooden pallets, and transported away from the production line for the necessary storage time. They must then be transported to the tumbler, depalletized, processed through the tumbler, and recubed and repalletized. All of this “off-line” processing is expensive. Additionally, there can be substantial spoilage of blocks that break apart in the tumbler. The tumbling apparatus itself can be quite expensive and a high maintenance item.

Retaining wall blocks can have relatively complex shapes. They are stacked into courses in use, with each course setback a uniform distance from the course below. Retaining walls must also typically have some shear strength between courses, to resist earth pressures behind the wall. A common way to provide uniform setback and course-to-course shear strength is to form an integral locator and shear key on the blocks. Commonly these keys take the form of lips (flanges) or tongue and groove structures (referred to generally herein as “lips”). Because retaining wall blocks range in size from quite small blocks (e.g., about 10 pounds and having a front face with an area of about 0.25 square foot) up to quite large blocks having a front face of a full square foot and weighing on the order of one hundred pounds, they may also be cored, or have extended tail sections. These complex shapes cannot survive the tumbling process. Lips get knocked off, and face shells get cracked through. As a consequence, the retaining wall blocks that do get tumbled are typically of very simple shapes, are relatively small, and do not have integral lips. Instead, they must be used with ancillary pins, clips, or other devices to establish setback and shear resistance. Use of these ancillary pins or clips makes it more difficult and expensive to construct walls than is the case with blocks having integral lips.

Another option for eliminating the regular edges and for creating an irregular face on a concrete block is to use a hammermill-type machine. In this type of machine, rotating hammers or other tools attack the face of the block to chip away pieces of it. These types of machines are typically expensive and require space on the production line that is often not available in block plants, especially older plants. This option can also slow down production if it is done “in line,” because the process can only move as fast as the hammermill can operate on each block, and the blocks typically need to be manipulated (e.g., flipped over and/or rotated) to attack all of their edges. If the hammermill-type process is done off-line, it creates many of the production inefficiencies described above with respect to tumbling.

An additional problem arises in a conventional retaining wall with setback courses. In a retaining wall in which each course is setback from the course below, a portion of the upper surface of each block in the lower course is visible between the front face of each block in the lower course and the front face of each block in the adjacent upper course. Typically, the visible upper surface portions are regular and planar, which creates the appearance of a ledge between each course. The ledges make the retaining wall less natural looking and are generally thought to detract from the appearance of the retaining wall.

One option for minimizing the appearance of a ledge is disclosed in U.S. patent application Ser. No. 10/103,155 (filed Mar. 20, 2002). As disclosed in that patent application, a splitting assembly includes a plurality of peaks disposed on one or both sides of a splitting line of a splitting assembly. The peaks, which are formed by a multiplicity of alternating ridges and valleys, form a serrated or saw-toothed appearance. When a workpiece is split, the peaks contact a lower surface of the workpiece adjacent a cleaving line along which the workpiece is to be split, so that, when the workpiece is split, each resulting block includes a chipped or roughened portion on a resulting upper surface of the block near the front face. This chipped or roughened portion, corresponding to a portion of the upper surface of the block that is visible due to the setback, enhances the natural appearance of this portion and minimizes the appearance of the ledge.

### SUMMARY OF THE INVENTION

The invention relates to equipment and related methods for producing concrete retaining wall blocks. When a plurality of blocks according to the invention is laid up in a wall with a setback between each course of blocks in the wall, the appearance of a ledge between the courses of blocks is minimized.

According to a first aspect, the invention relates to a method of producing a concrete block, the method including the steps of: providing a concrete workpiece to be split along a cleaving line, the workpiece having a lower surface; roughening at least a portion of the lower surface on at least one side of and adjacent to the cleaving line; and, in a step separate from the roughening step, splitting the workpiece along the cleaving line into at least two pieces, wherein at least one of the split pieces is the concrete block.

In another aspect, the invention relates to a method of producing a concrete block having a roughened front face and a top surface having at least a roughened portion that intersects the front face. The method comprises: providing a concrete block splitter having a roughening assembly and at least one splitting assembly for splitting a concrete workpiece; providing a concrete workpiece to be split along a cleaving line, the workpiece having a surface on one side of the cleaving line that will form the top surface of the block; using the roughening assembly to roughen at least a portion of the workpiece surface adjacent the cleaving line; and thereafter locating the workpiece in the concrete block splitter and splitting the workpiece along the cleaving line into at least two pieces using the splitting assembly, wherein at least one of the split pieces is the concrete block having a roughened front face and a roughened top surface portion that intersects the front face.

In yet another aspect, the invention relates to a roughening assembly comprising a rotatable shaft including a plurality of roughening members, the shaft being positioned adjacent to a work surface and having at least a portion of each of the roughening members positioned to be rotated by the shaft into engagement with a lower surface of a concrete workpiece moving along the work surface. The shaft is rotated as a concrete workpiece moves along the work surface so that the roughening members contact and roughen at least a portion of the lower surface of the concrete workpiece.

In another aspect, the invention relates to a concrete block resulting from processing a molded concrete workpiece in a block splitter having a roughening assembly configured to perform a roughening operation on the workpiece, and at least one splitting assembly configured to split the workpiece along a cleaving line in a splitting operation separate from the roughening operation, the roughening assembly including a plurality of roughening members that are positioned to engage a lower surface of the workpiece on at least one side of and adjacent to the cleaving line during the roughening operation. The concrete block comprises a block body including a top surface, a bottom surface, a front face extending between the top and bottom surfaces, a rear surface extending between the top and bottom surfaces, and side surfaces between the front face and the rear surface; a locator protrusion formed integrally with the block body and disposed on the top or bottom surface thereof; the front face is irregular, and a portion of the top surface adjacent the front face is roughened, the roughened top surface portion resulting from the plurality of roughening members contacting the lower surface of the workpiece adjacent to the cleaving line during the roughening operation.

In yet another aspect, the invention relates to a block splitter that includes a roughening assembly that is arranged and configured to roughen at least a portion of a lower surface of a concrete workpiece, and at least one splitting assembly positioned downstream from the roughening assembly for splitting the workpiece along the cleaving line into at least two pieces.

These and various other advantages and features of novelty which characterize the invention are pointed out with particularity in the claims annexed hereto and forming a part hereof. However, for a better understanding of the invention, its advantages and objects obtained by its use, reference should be made to the drawings which form a further part hereof, and to the accompanying description, in which there is described a preferred embodiment of the invention.

### BRIEF DESCRIPTION OF THE DRAWINGS

FIG. 1 is a perspective view of a roughening assembly for use in a block splitting machine.

FIG. 2 is a top view of the roughening assembly shown in relation to a workpiece that is to be roughened, as well as a downstream splitting assembly.

FIG. 3 is a side view of the roughening assembly with a workpiece positioned to be roughened.

FIG. 4 is a perspective view of a concrete block that includes an entire top surface that has been roughened using a roughening assembly of the type illustrated in FIG. 3.

FIG. 5 is a side view of the concrete block of FIG. 4.

FIG. 6A illustrates a wall under construction and including a plurality of blocks of FIG. 4.

FIG. 6B illustrates a side cross-sectional view of a wall constructed from a plurality of blocks of FIG. 4.

FIG. 7 is a side view of another embodiment of a roughening assembly, which includes a moveable shaft.

FIG. 8 is a perspective view of a concrete block that includes a portion of a top surface that has been roughened using a roughening assembly of the type illustrated in FIG. 7.

FIG. 9 is a perspective view of a roughening assembly, which includes an embodiment of a biasing assembly.

### DETAILED DESCRIPTION OF THE PREFERRED EMBODIMENTS

The invention relates generally to the processing of concrete workpieces to create a more natural appearance to the top surface of concrete retaining wall blocks. More specifically, the invention relates to systems and methods for roughening at least a portion of a top surface adjacent the front face of a concrete block.

Equipment and processes that create a more natural appearing block front face and that eliminate the regular, sharp face edges are disclosed in commonly assigned, copending U.S. patent application Ser. No. 09/884,795 (filed Jun. 19, 2001), Ser. No. 09/691,864 (filed Oct. 19, 2000), and Ser. No. 10/103,155 (filed Mar. 20, 2002), and in U.S. Pat. No. 6,321,740, which are incorporated herein by reference in their entirety. As disclosed in these documents, at least one splitting assembly of a block splitting mechanism in a block splitting machine is provided with a plurality of projections that are disposed on at least one side of a splitting line of the block splitting mechanism with which a concrete workpiece to be split is aligned. The splitting line is an imaginary line in the block splitting mechanism. However, the splitting line could be an actual line provided in the block splitting mechanism to provide a visual reference to users of the splitting mechanism.

In addition, the workpiece has what can be referred to as a cleaving line along which the workpiece is to be split. The cleaving line is typically an imaginary line on the workpiece. However, the cleaving line could be an actual line or structure, for example a pre-formed splitting groove of the type disclosed in U.S. Pat. No. 6,082,057, provided on the workpiece.

Prior to splitting, the workpiece is positioned in the block splitting mechanism so that the cleaving line is aligned with the splitting line. Thereafter, the one or more splitting assemblies of the block splitting mechanism are brought into engagement with the workpiece, with the projections engaging the workpiece on at least one side of the aligned splitting line and cleaving line. It is to be realized that the shape of the splitting line and cleaving line can vary depending upon the desired shape of the block front face. The splitting and cleaving lines can be straight and linear for a planar block front face; the splitting and cleaving lines can be faceted for a multi-faceted block front face; and the splitting and cleaving lines can be arcuate for a curved block front face. Other front face shapes are possible, in which case the splitting and cleaving lines will have a shape that generally corresponds to the desired block front face shape.

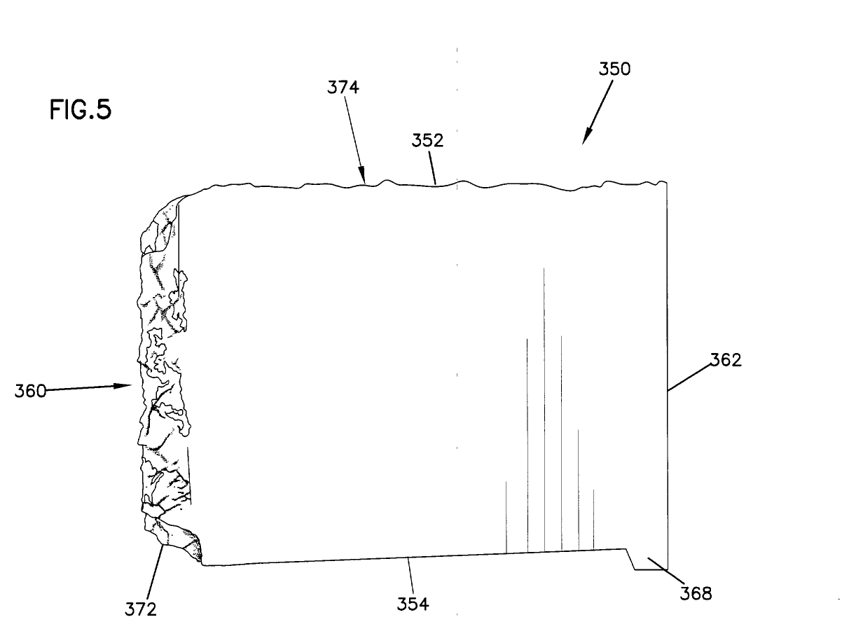

The projections are positioned to engage the workpiece during splitting to create an irregular front face and an irregular upper or lower front edge on the resulting block. A typical workpiece that is split is formed by two blocks molded from no-slump concrete in a face-to-face arrangement so that splitting of the workpiece creates irregular front faces on both blocks. See, e.g., FIGS. 4, 5, and 8, described further below.

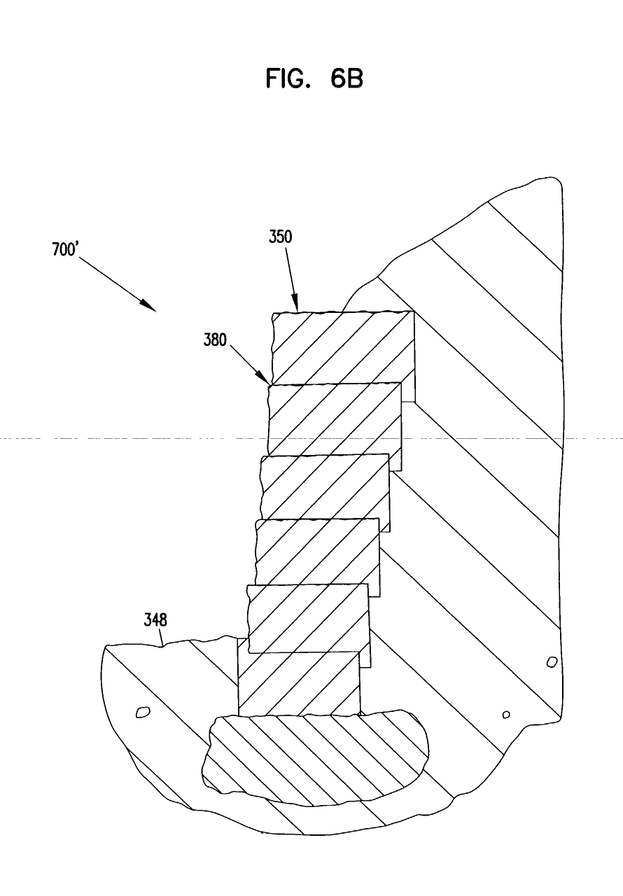

The block or blocks that result from splitting the workpiece are laid together with additional blocks to form courses in a wall. See, e.g., FIGS. 6A and 6B, described further below. Because each course of blocks is setback from the course below, a portion of the top surface of each block in each lower course is visible after the wall is constructed. It is desirable to maximize the natural appearance of this exposed top surface of each block, as disclosed herein.

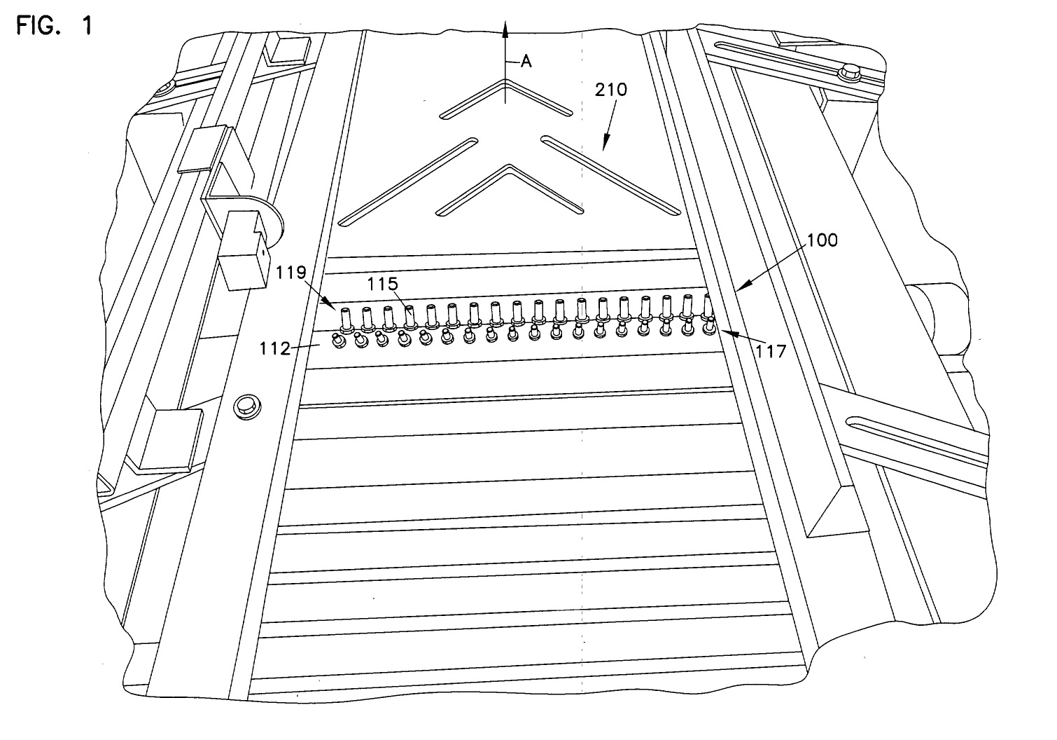

Referring now to FIGS. 1-3, a portion of a concrete block splitting machine, including an example of a roughening assembly 100 of the invention, is illustrated. The assembly 100 is positioned upstream of a splitting mechanism 400 that includes at least one splitting assembly. Preferably, the splitting mechanism 400 comprises two opposed splitting assemblies, one assembly positioned below a workpiece to be split and one positioned above a workpiece to be split. The splitting assemblies are preferably of the type disclosed in U.S. patent application Ser. Nos. 09/884,795, 09/691,864, and 10/103,155, or in U.S. Pat. No. 6,321,740. The splitting mechanism 400 functions to split a workpiece along a cleaving line into one or more resulting blocks, usually into two similar, essentially identical blocks.

The roughening assembly 100 generally includes a shaft 112 including a plurality of roughening members 115 fixed thereto. In the illustrated embodiment, the roughening members 115 comprise bolts. The roughening members 115 may also be formed using other components to provide the desired roughening of the workpiece.

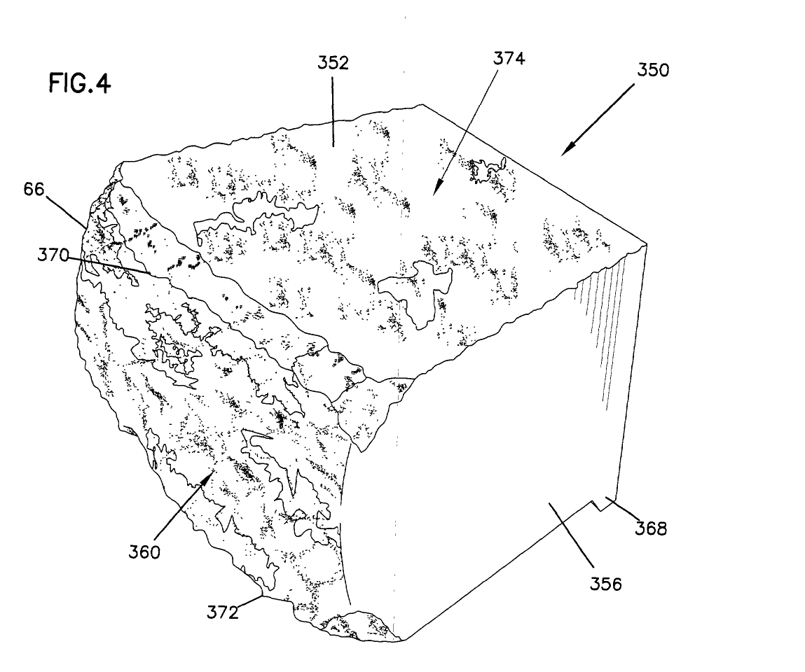

As illustrated in FIG. 3, the roughening members 115 extend radially from the periphery of the shaft 112. A motor 120 is coupled to the shaft 112 to rotate the shaft 112 in a direction X opposed to the direction of movement of the concrete workpiece. As the shaft 112 is rotated and the roughening members 115 pass through an axis Y above the shaft, the roughening members 115 extend at least partially above a work surface 210 to contact the workpiece as the workpiece is moved along the work surface.

In the illustrated embodiment, the roughening members 115 are positioned generally in two parallel rows 117 and 119, each row being slightly offset along the length of the shaft with respect to the other. In the embodiment shown, the roughening members 115 comprise threaded bolts screwed into complementary-threaded apertures formed in the shaft 112. In the illustrated embodiment, the roughening members are each about 3/8 inches in diameter and extend 1½ inches from the periphery of the shaft 112, so that approximately 1/8 inch of each roughening member extends above the work surface 210. The roughening members 115 may alternatively be made of carbide-tipped metal projections similar to those disclosed in U.S. patent application Ser. No. 10/103,155, which can be obtained from Fairlane Products Co. of Fraser, Mich. The shaft 112 is about 2 inches in diameter. Other sizes and types of roughening members and shafts may also be used.

In alternative embodiments, additional rows of roughening members may be added, or the roughening members may be randomly spaced around the periphery of the shaft rather than being placed in parallel rows. In another alternative embodiment, the roughening members may be arranged in a helix around the shaft.

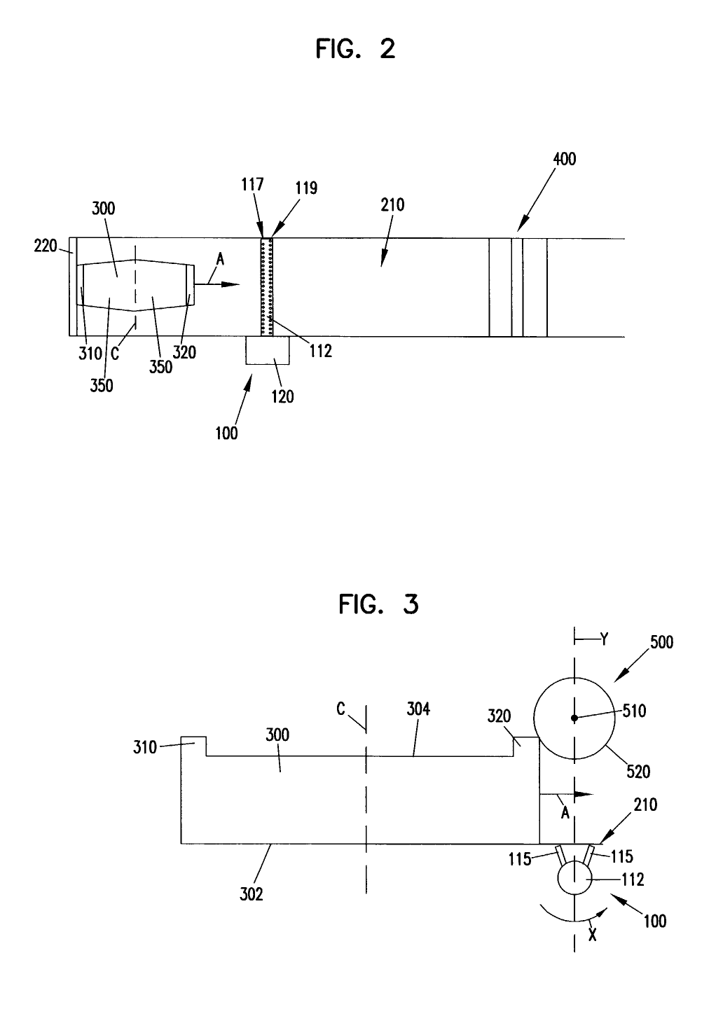

Referring again to FIGS. 2 and 3, a concrete workpiece 300 (comprising two retaining wall blocks 350 molded face to face to be separated by splitting along cleaving line C) is shown relative to the roughening assembly 100. The workpiece 300 includes a lower surface 302, an upper surface 304, and lips 310 and 320 integrally formed on and extending from the upper surface 304. When referring to the concrete workpiece 300, the terms “upper” and “lower” refer to the position of the workpiece relative to the roughening assembly 100 during roughening and splitting. The workpiece is preferably oriented “lips up” during roughening and splitting. This “lips up” orientation allows the workpiece to lay flat on what will be the top surface of the resulting concrete blocks when the blocks are laid in a wall. In other words, the lower surface 302 of the workpiece 300 becomes the top surface of the resulting blocks when the blocks are laid in the wall.

The workpiece 300 is moved along the work surface 210 in a direction A by a pusher bar 220. As the workpiece 300 approaches the shaft 112, the shaft 112 is rotated in the direction X opposite the direction A of the moving workpiece 300. As the workpiece 300 passes over the shaft 112, the plurality of roughening members 115 contact the lower surface 302 of the workpiece 300 a plurality of times, thereby roughening the lower surface 302.

The speed that the shaft is rotated and that the workpiece is moved past the roughening assembly may be varied depending on the desired roughening of the lower surface 302 of the workpiece. For example, in one embodiment, the shaft was rotated at approximately 500 RPM and the workpiece was conveyed at approximately 8 inches/second.

Once the lower surface 302 of the workpiece 300 has been roughened, the workpiece is conveyed along a conveyor apparatus in the direction A to the downstream splitting mechanism 400 that includes the splitting assemblies (see FIG. 2). Once the workpiece 300 is positioned in the splitting mechanism 400, with the cleaving line thereof aligned with the splitting line, the workpiece 300 is split along the cleaving line C into two blocks by the splitting mechanism. The cleaving line C may be straight (as shown) in which case the resulting blocks will have generally planar front faces, or nonlinear to form blocks with non-planar, for example faceted or curved, front faces.

As shown in FIG. 3, a biasing assembly 500 may also be provided to resiliently bias the workpiece 300 against the work surface 210 as the workpiece is roughened by the assembly 100. In the illustrated embodiment, the biasing assembly 500 comprises at least one rubber tire 520 configured to rotate about a central axis 510. The biasing assembly 500 is positioned so that the tire 520 contacts the upper surface 304 of the workpiece 300 as the workpiece is conveyed along the work surface 210 in the direction A. The tire 520 rotates about the axis 510 as the tire 520 rides over the upper surface 304 of the workpiece 300 and functions to bias the workpiece against the work surface 210 as the lower surface 302 is roughened.

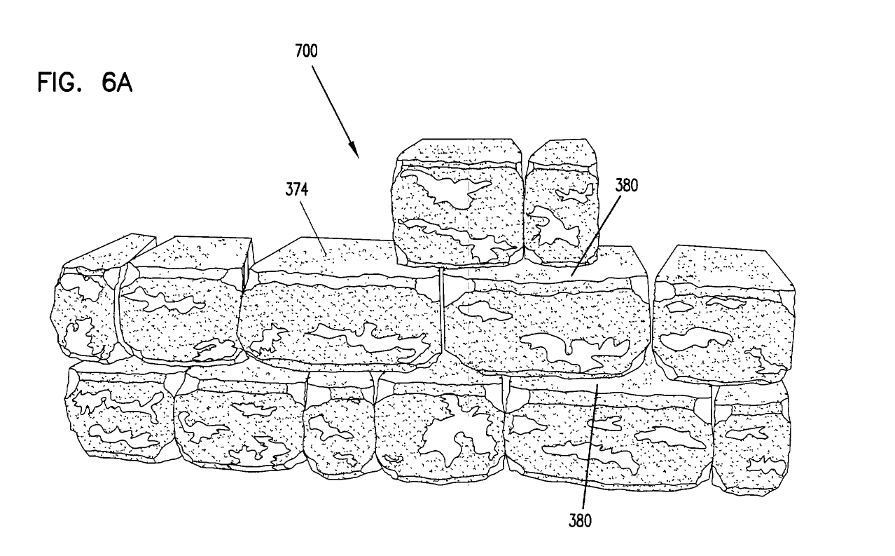

A block 350 that results from the workpiece 300 being roughened and split, as described above, is illustrated in FIGS. 4 and 5. The block 350 includes a block body with a top surface 352, a bottom surface 354, side surfaces 356 (only one side surface is visible in FIGS. 4 and 5—the other side surface is a mirror image of the face seen in FIGS. 4 and 5), a front face 360 and a rear surface 362. When referring to the concrete block 350, the terms “top” and “bottom” refer to the position of the block when placed in a wall (see, e.g., FIG. 6). This is opposite to the designation of the upper and lower surfaces of the workpiece 300 described above during processing.

The block 350 includes a locator lip 368 (corresponding to lips 310 or 320 of the workpiece 300) formed integrally on the bottom surface 354 adjacent to, and preferably forming a portion of, the rear surface 362. The lip 368 establishes a uniform set back for a wall formed from the blocks 350 and provides resistance to shear forces. See FIGS. 6A and 6B. In the preferred configuration, the lip 368 is continuous from one side of the block 350 to the other side. However, the lip 368 need not be continuous from one side to the other side, nor does the lip 368 need to be contiguous with the rear surface 362.

In the block of FIGS. 4 and 5, the top and bottom surfaces 352 and 354 do not have to be planar, but they do have to be configured so that, when laid up in courses, the block tops and bottoms in adjacent courses stay parallel to each other and are generally horizontal. Further, the front face 360 of each block is wider than the rear surface 362, which is achieved by angling at least one of the side surfaces 356, preferably both side surfaces, so that the side surfaces get closer together (converge) as they approach the rear surface. Such a construction permits the blocks to be rotated with respect to one another so that serpentine walls can be constructed. It is also contemplated that the side surfaces 356 can start converging from a position spaced rearwardly from the front face 360. This permits adjacent blocks to abut slightly behind the front face along regular surfaces that have not been altered by the action of the splitting assembly 400 or the roughening assembly 100, which in turn, makes it less likely that materials behind the wall can seep out through the face of the wall.

The top surface 352 of the block 350 includes a chipped or roughened portion 374 formed by the roughening assembly 100. In the block 350 of FIGS. 4 and 5, the roughened portion 374 extends the entire length of the top surface 352. The roughened portion 374 helps to minimize the appearance of a ledge when a plurality of similar blocks 350 are laid up in a wall 700 with a set-back between each course of blocks in the wall 700 (see FIG. 6).

FIG. 6A illustrates a wall 700 under construction and including a plurality of the blocks 350. FIG. 6B illustrates a completed wall 700′ positioned in the ground 748. Generally, construction of a structure such as a retaining wall 700′ may be undertaken by first defining a trench area beneath the plane of the ground 348 in which to deposit a first course of blocks 350. Once defined, the trench is partially refilled and flattened. The first course of blocks is then laid into the trench. The first course of blocks may often comprise blocks which are laid on their back in order to define a pattern or stop at the base of the wall. As can be seen in FIGS. 6A and 6B, successive courses of blocks are then stacked on top of preceding courses while backfilling the wall with soil. As stability is dependent upon weight and minimal setback, the minimal setback provided by the blocks of the present invention assists in further stabilizing the blocks.

Since each course is setback from the course below, a portion 380 of the top surface 352 of each block 350 in the lower course is visible between the front face 360 of each block 350 in the lower course and the front face 360 of each block in the adjacent upper course. In the absence of the treatment described herein, the entire portion 380 is regular and planar, which creates the appearance of a ledge between each course. However, as a result of the action of the roughening assembly 100, the visible portions 380 are irregular and non-planar, thereby minimizing the appearance of the ledge and making the wall 700 and the blocks 350 from which it is formed appear more natural.

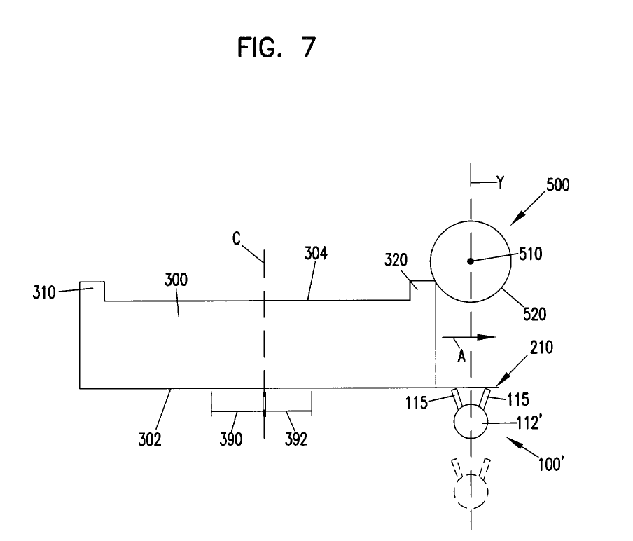

Referring now to FIG. 7, another embodiment of a roughening assembly 100′ is shown. The roughening assembly 100′ is similar to the assembly 100 described above, except that the roughening assembly 100′ includes a shaft 112′ that is moveable vertically. Specifically, the shaft 112′ is moveable between a first position and a second position. In the first position, as illustrated in FIG. 7, the shaft 1112′ is positioned so that the roughening members 115 can extend at least partially into the path of the workpiece to roughen the lower surface of the workpiece 300. In the second position, illustrated by the broken lines shown in FIG. 7, the shaft 112′ is moved so that the roughening members 115 do not extend above the work surface 210 and, therefore, cannot contact the lower surface of the workpiece 300. In this configuration, the assembly 100′ allows the shaft 112′ to be moved into the first position to roughen the workpiece and moved out of position into the second position when desired.

The assembly 100′ may be used to roughen only a portion of the lower surface 302 of the workpiece 300. With the shaft 112′ in the second position, the workpiece 300 is conveyed so that a portion 392 of the lower surface 302 adjacent the cleaving line C along which the workpiece 300 is to be split is positioned above the shaft 112′. The shaft 112′ is then moved into the first position and rotated in the direction X, and the workpiece 300 is moved in the direction A until the cleaving line C has passed the shaft 112′, allowing the roughening members to contact the workpiece. The shaft 112′ is then moved back to the second position so that the roughening members cannot contact the workpiece 300.

In this manner, only portions 390 and 392 of the lower surface 302 adjacent the cleaving line C along which the workpiece is to be split are roughened. When the workpiece 300 is subsequently split, the roughened portions 390 and 392 are adjacent and intersect the front face of each resulting block 350′.

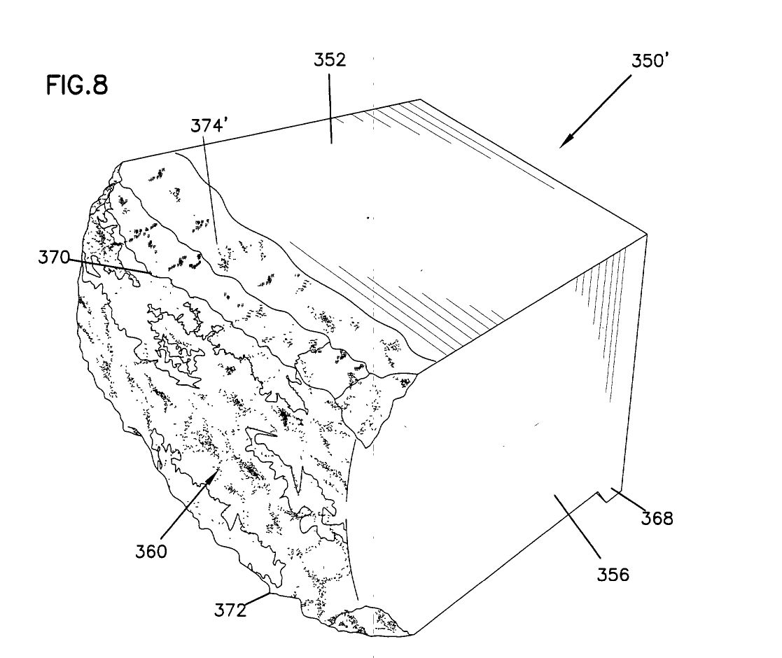

As shown in FIG. 8, each resulting block 350′ includes a portion 374′ (corresponding to either roughened portion 390 or 392 of the workpiece 300) of the top surface 352 that has been roughened. When placed in a wall (such as wall 700 shown in FIG. 6), the portion 374′ would function to enhance the natural appearance of the block and minimize the appearance of the ledge 380 formed between courses. In this embodiment, the portion 374′ is sized so that the exposed portion of the entire ledge is roughened.

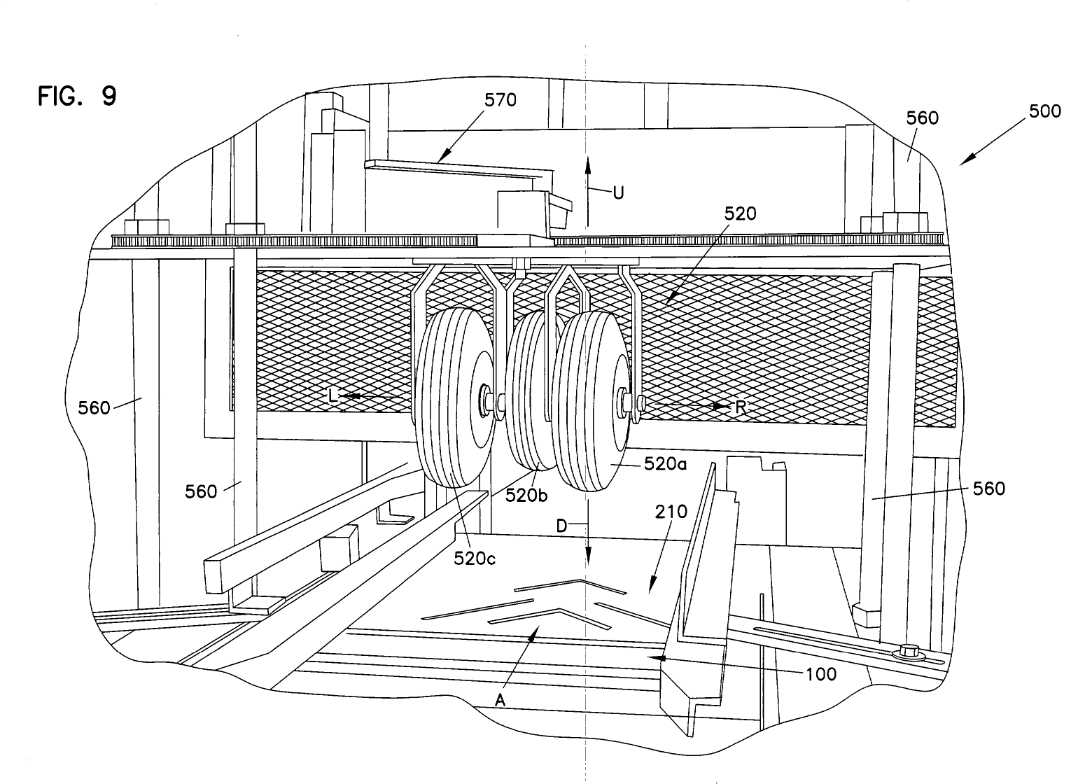

Referring now to FIG. 9, an embodiment of the biasing assembly 500 is shown in greater detail. In this embodiment, the assembly 500 includes three tires 520a, 520b, and 520c positioned to bias a workpiece. The tires 520a, 520b, and 520c may be positioned to be slightly offset with respect to one another. For example, in the embodiment shown, each tire is positioned to contact a slightly different portion of a workpiece as the workpiece passes along the work surface. In addition, the tire 520b is positioned slightly downstream from the tires 520a and 520c.

The assembly 500 allows the tires 520 to move upward and downward along supports 560 in directions U and D by rotation of a crank 570. In addition, the tires 520 may be adjusted in left and right directions L and R to contact different portions of a workpiece. The adjustment of the tires in the various directions allows the roughening assembly 100 to accommodate workpieces of different sizes.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of producing a concrete block, comprising:
providing a concrete workpiece to be split along a cleaving line, the workpiece having a lower surface;
roughening at least a portion of the lower surface on at least one side of and adjacent to the cleaving line; and
splitting, in a step separate from the roughening step, the workpiece along the cleaving line into at least two pieces, wherein at least one of the split pieces is the concrete block.

2. The method of claim 1, wherein the roughening step further comprises roughening an entirety of the lower surface on at least one side of the cleaving line.

3. The method of claim 1, wherein the roughening step further comprises roughening an entirety of the lower surface of the workpiece.

4. The method of claim 1, wherein the roughening step further comprises:
providing a rotatable shaft including a plurality of roughening members;
locating the rotatable shaft adjacent to a work surface, the rotatable shaft being positioned so that the plurality of roughening members are positioned to make contact with the lower surface of the workpiece when the workpiece is supported by the work surface; and
rotating the shaft as the workpiece passes adjacent the shaft so that the plurality of roughening members contact and roughen the portion of the lower surface of the concrete workpiece.

5. The method of claim 4, further comprising a step of moving the shaft into position to roughen the lower surface of the concrete workpiece when the concrete workpiece is positioned over the shaft so that only a portion of the lower surface adjacent to the cleaving line is roughened.

6. The method of claim 4, wherein the rotating step comprises rotating the shaft in a direction opposed to the direction of movement of the workpiece as the workpiece is roughened.

7. The method of claim 1, wherein the splitting step further comprises splitting the workpiece in a block splitter having at least one splitting assembly.

8. The method of claim 1, comprising applying a biasing force to the workpiece during roughening, the biasing force being applied in a direction substantially perpendicular to the lower surface.

9. The method of claim 8, wherein the biasing force is applied by a biasing assembly that is positioned to engage an upper surface of the workpiece.

10. The method of claim 9, further comprising the step of adjusting the biasing assembly to accommodate workpieces of varying sizes.

11. The method of claim 9, further comprising the step of allowing a tire of the biasing assembly to contact the upper surface of the workpiece as the workpiece is roughened.

12. A method of producing a concrete block having a roughened front face and a top surface having at least a roughened portion that intersects the front face, comprising:
providing a concrete block splitter having a roughening assembly and at least one splitting assembly for splitting a concrete workpiece;
providing a concrete workpiece to be split along a cleaving line, the workpiece having a surface on one side of the cleaving line that will form the top surface of the block;
using the roughening assembly to roughen at least a portion of the workpiece surface adjacent the cleaving line; and thereafter
locating the workpiece relative to the splitting assembly and splitting the workpiece along the cleaving line into at least two pieces using the splitting assembly, wherein at least one of the split pieces is the concrete block having a roughened front face and a roughened top surface portion that intersects the front face.

13. The method of claim 12, wherein the workpiece includes surfaces on each side of the cleaving line, and the roughening assembly is used to roughen at least a portion of each surface adjacent the cleaving line, and the two pieces formed by splitting the workpiece are two similar concrete blocks having a roughened front face and a roughened top surface portion that intersects the front face.

14. The method of claim 12, wherein the step of using the roughening assembly further comprises using the roughening assembly to roughen substantially all of the surface that will form the top surface of the block.

15. A roughening assembly comprising a rotatable shaft including a plurality of roughening members, the shaft being positioned adjacent to a work surface and having at least a portion of each of the roughening members positioned to be rotated by the shaft into engagement with a lower surface of a concrete workpiece moving along the work surface, the shaft being rotated as a concrete workpiece moves along the work surface so that the roughening members contact and roughen at least a portion of the lower surface of the concrete workpiece.

16. The assembly of claim 15, further comprising a biasing assembly positioned generally over the work surface and spaced apart from the shaft, the biasing assembly configured to engage an upper surface of the concrete workpiece as the roughening members engage the lower surface.

17. The assembly of claim 16, wherein the biasing assembly is adjustable to accommodate workpieces of varying sizes.

18. The assembly of claim 16, wherein the biasing assembly includes at least one rotatable tire positioned to contact and ride along the upper surface of the concrete workpiece.

19. A concrete block resulting from processing a molded concrete workpiece in a block splitter having a roughening assembly configured to perform a roughening operation on the workpiece, and at least one splitting assembly configured to split the workpiece along a cleaving line in a splitting operation separate from the roughening operation, the roughening assembly including a plurality of roughening members that are positioned to engage a lower surface of the workpiece on at least one side of and adjacent to the cleaving line during the roughening operation, the concrete block comprising:
a block body including a top surface, a bottom surface, a front face extending between the top and bottom surfaces, a rear surface extending between the top and bottom surfaces, and side surfaces between the front face and the rear surface; a locator protrusion formed integrally with the block body and disposed on the top or bottom surface thereof; the front face is irregular, and a portion of the top surface adjacent the front face is roughened, the roughened top surface portion resulting from the plurality of roughening members contacting the lower surface of the workpiece adjacent to the cleaving line during the roughening operation.

20. The block of claim 19, wherein the entire top surface of the block body is roughened.

21. The block of claim 19, wherein the intersection of the front face and the top surface defines an upper edge, and the intersection of the front face and bottom surface defines a lower edge, and wherein at least a portion of one of the upper and lower edges is irregular.

22. The block of claim 21, wherein the upper and lower edges are irregular.

23. A block splitting machine comprising:
a roughening assembly arranged and configured to roughen at least a portion of a lower surface of a concrete workpiece; and
at least one splitting assembly positioned downstream from the roughening assembly, the splitting assembly splitting the workpiece along a cleaving line into at least two pieces.

24. The block splitting machine of claim 23, wherein the roughening assembly includes a rotatable shaft and a plurality of roughening members, the shaft being positioned adjacent to a work surface so that the plurality of roughening members are positioned to contact a lower surface of a concrete workpiece supported by the work surface.

25. The block splitting machine of claim 23, further comprising a conveyor apparatus between the roughening assembly and the at least one splitting assembly for transporting a workpiece from the roughening assembly to the at least one splitting assembly.
